(19) United States
(12) Patent Application Publication
(10) Pub. No.: US 2026/0349597 A1
(43) Pub. Date: Nov. 5, 2026

(54) UNIFIED MANAGEMENT SYSTEM FOR NVMe DRIVES IN SERVER ENVIRONMENTS

(71) Applicant: Aivres Systems Inc., San Jose, CA (US)

(72) Inventor: Guan Long Huang, New Taipei City (TW)

(21) Appl. No.: 19/197,614

(22) Filed: May 2, 2025

(51) Int. Cl. G06F 3/06

(52) U.S. Cl. CPC G06F 3/0604; G06F 3/0629; G06F 3/0679

(57) ABSTRACT

A system for managing NVMe storage devices is disclosed. The system includes a Baseboard Management Controller (BMC), a peripheral interface controller, and at least one NVMe drive. The BMC is configured to retrieve drive configuration data from the NVMe drive and transmit a control signal based on the drive configuration data to the peripheral interface controller. Based on the control signal, the peripheral interface controller communicates with a clock buffer via SMBus to dynamically adjust clock spread spectrum settings, optimizing electromagnetic interference (EMI) performance.

### TECHNICAL FIELD

The present invention relates to the management of NVMe (Non-Volatile Memory Express) drives in server environments, specifically focusing on optimizing thermal, power, and signal control mechanisms to improve system efficiency, reduce production complexity, and enhance the adaptability of server configurations.

### BACKGROUND

NVMe drives have emerged as a preferred storage solution in server systems due to their high data transfer speeds and low latency, enabling superior performance for data-intensive applications. However, the integration of NVMe drives into server environments has become increasingly complex due to variations in drive designs and manufacturer-specific requirements. Current approaches require maintaining multiple configurations for hardware and firmware, which increases production costs, complicates system management, and introduces risks of errors and inefficiencies.

These challenges also place significant burdens on system development and maintenance, including the need for extensive debugging, additional training, and managing diverse compatibility requirements. Moreover, traditional methods of managing power, thermal performance, and signal quality often result in inefficiencies, particularly in large-scale server deployments.

To address these limitations, there is a pressing need for a unified management system that simplifies the integration of NVMe drives, reduces hardware complexity, and minimizes maintenance efforts. Such a system would enhance operational efficiency, streamline production processes, and improve the overall reliability and adaptability of server environments.

### SUMMARY

A system comprising one or more computers may be configured to perform specific operations by utilizing software, firmware, hardware, or a combination thereof. The system executes these operations through installed components that, when in operation, enable it to perform the specified actions. Similarly, one or more computer programs may be configured to execute specific operations by containing instructions that, when processed by a data processing apparatus, cause it to carry out the intended functions.

In one general aspect, the system includes a Baseboard Management Controller (BMC), a Platform Controller Hub (PCH), and at least one NVMe drive. Here, the PCH as used herein refers to a peripheral interface controller that manages peripheral interfaces, including PCIe, SMBus, and other I/O protocols, and is not limited to any particular manufacturer. The BMC is configured to communicate with the NVMe drive to retrieve its configuration data and transmit this data to the PCH. The PCH, in turn, determines, based on the configuration data, whether to enable SSC and communicates with a clock buffer via SMBus to adjust clock spread spectrum settings based on the retrieved drive configuration data. Other embodiments of this system include corresponding computer systems, apparatuses, and computer programs stored on one or more computer storage devices, each designed to perform the specified operations.

The system may further be configured to enable or disable the 100 MHz clock spread spectrum for the NVMe drive based on device model information contained in the drive configuration data. The drive configuration data may include information such as the manufacturer, model number, power consumption, and operating characteristics of the NVMe drive. The BMC may retrieve this data via an I2C-connected switch or an SMBus using an NVMe Management Interface (NVMe-MI) and transmit it to the PCH through an Enhanced Serial Peripheral Interface (eSPI) interface. Here, NVMe-MI is the protocol (application-layer) that utilizes the I2C-connected switch or SMBus as a physical transport layer (physical layer) for NVMe storage device management. Based on the retrieved drive configuration data, the PCH may determine whether to enable or disable a spread spectrum clock (SSC) feature to mitigate electromagnetic interference (EMI).

The system also allows the BMC to store pre-configured equalization (EQ) values for multiple NVMe drive models and to select an appropriate EQ value for a given NVMe drive based on its model information. The selected EQ value is then transmitted to a PCIe retimer via I2C, allowing the retimer to adjust the PCIe signal integrity accordingly. Additionally, the BMC may monitor the power consumption of the NVMe drive through eFuse feedback and dynamically adjust server cooling parameters based on the monitored power consumption, optimizing the system's thermal management. The PCH may further be configured to regulate clock synchronization for the NVMe drive.

Implementations of the described techniques may be realized through hardware, methods or processes, or computer-readable storage media. In one general aspect, a method includes retrieving drive configuration data from at least one NVMe drive by the BMC, transmitting the drive configuration data to the PCH, and adjusting, by the PCH via communication with a clock buffer over I2C-based switch or SMBus, a clock spread spectrum setting based on the drive configuration data. Other embodiments of this method include corresponding computer systems, apparatuses, and computer programs stored on one or more computer storage devices, each configured to perform the specified operations.

In another general aspect, the BMC includes functionality to communicate with at least one NVMe drive to retrieve drive configuration data and transmit it to the PCH for system configuration adjustments. Other embodiments include corresponding computer systems, apparatuses, and computer programs stored on one or more computer storage devices, each designed to execute the described methods.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 shows an example unified management system for NVMe drives, according to one example embodiment.

FIG. 2 is an example signal path for the Baseboard Management Controller (BMC) to retrieve NVMe configuration data via NVMe Management Interface (NVMe-MI), according to one example embodiment.

FIG. 3 is an example signal path for the BMC to dynamically control spread spectrum clocking (SSC) through the clock buffer, according to one example embodiment.

FIG. 4 is an example signal path for the BMC to select and apply equalization (EQ) values to the PCIe retimer, according to one example embodiment.

FIG. 5 is an example signal path for BMC to use eFuse feedback to dynamically adjust fan speed based on NVMe power consumption, according to one example embodiment.

FIG. 6 illustrates an example method for managing NVMe drives using the unified management system, according to one example embodiment.

FIG. 7 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

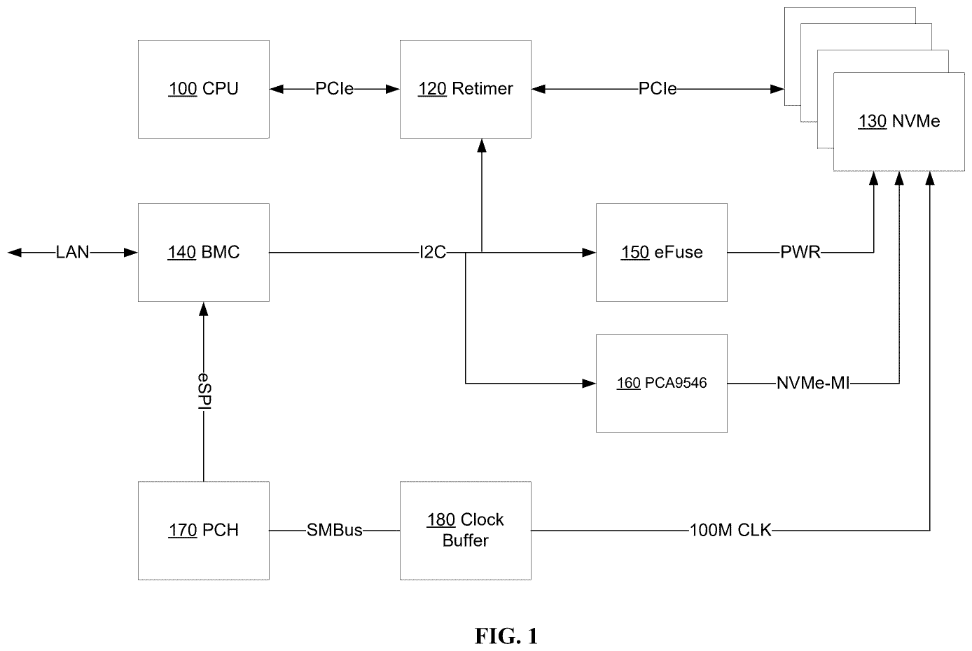

FIG. 1 shows an example unified management system for NVMe drives, according to one example embodiment. The system architecture integrates a Baseboard Management Controller (BMC) 140, a Platform Controller Hub (PCH) 170, and a plurality of NVMe drives 130 as key components. Additionally, the system includes a CPU 100, a Retimer 120, an eFuse 150, a switch (e.g., PCA9546) 160, and a clock buffer 180. These components collectively form a management framework that optimizes NVMe drive performance through dynamic configuration and monitoring.

The CPU 100 interfaces with the Retimer 120 via a two-way PCIe link, ensuring high-speed data transmission. Similarly, the Retimer 120 is connected to the NVMe drives 130 through another two-way PCIe link. The BMC 140, a central component of the system, has a LAN connection that allows remote accessibility and system monitoring by users. Additionally, the BMC 140 communicates with the PCH 170 via an eSPI connection, enabling coordination between system management components.

To facilitate efficient drive configuration and power management, in one embodiment, the BMC 140 has an outgoing I2C connection or SMBus connection that is split into three distinct paths, respectively linking to the Retimer 120, eFuse 150, and switch 160 (e.g., PCA9546 in FIG. 1). The eFuse 150 is further connected to the NVMe drives 130 through a Power (PWR) link, allowing the system to monitor power consumption and dynamically adjust cooling strategies. The switch 160 interfaces with the NVMe drives 130 through an NVMe Management Interface (NVMe-MI), enabling the BMC to retrieve drive configuration data, including manufacturer, model, capacity, and power consumption.

For clock management, the PCH 170 communicates with a clock buffer 180 through an SMBus connection. The clock buffer 180 is responsible for generating a 100 MHz clock signal for the NVMe drives 130, ensuring proper timing synchronization. Based on the NVMe drive configuration data retrieved by the BMC, the PCH 170 dynamically adjusts the clock spread spectrum settings via the clock buffer 180 to mitigate electromagnetic interference (EMI) issues.

The system implements several features to enhance performance and reliability. First, the BMC 140 retrieves drive model information and sends the drive mode information to the PCH 170 via eSPI, which then determines whether spread spectrum clocking (SSC) should be enabled based on prior testing results and manufacturer-provided errata documentation, and then communicates with the clock buffer 180 via SMBus to adjust SSC settings, ensuring regulatory compliance and system stability.

Second, the system employs a dynamic PCIe retimer equalization (EQ) adjustment mechanism. Prior to full system boot (e.g., during early initialization or pre-boot environment), the BMC 140 detects the NVMe drive model and accesses a pre-stored table of optimized EQ values in its ROM, based on prior tuning for different drive types. The BMC 140 then transmits the appropriate EQ value to the Retimer 120 via I2C or SMBus, ensuring optimal PCIe signal integrity across various NVMe drive configurations. Here, I2C and SMBus may have the same underlying protocol, and the difference between them is SMBus has extra Alert_N pin to inform the host when there has some error event happened on the bus.

Third, the system incorporates a power and thermal management strategy. The eFuse 150 provides real-time power consumption feedback to the BMC 140. When the BMC 140 detects sustained high current consumption from an NVMe drive 130, it increases the system's fan speed to dissipate heat more effectively. Conversely, when power consumption decreases, the BMC 140 lowers fan speed, optimizing power efficiency and reducing noise levels.

The above-described new logics and data/control paths are implemented in the BMC firmware to enhance its performance. These enhancements allow the BMC to dynamically configure signal parameters, optimize power usage, and manage thermal conditions without requiring additional hardware modifications.

In some embodiments, to implement these new capabilities, the BMC firmware is updated to support additional tasks, such as retrieving NVMe drive information through the NVMe-MI via I2C or SMBus. During system startup, the BMC queries each NVMe drive to obtain essential configuration details, including manufacturer, model number, power consumption, and operational characteristics. BMC then sends this information to PCH 170 to determine appropriate system settings, such as whether to enable spread spectrum clocking or adjust the PCIe retimer's EQ values. These decision-making processes are based on predefined rules stored in the PCH's memory, which may include manufacturer-provided errata and prior test results.

The BMC communicates with other system components using existing interfaces, eliminating the need for additional hardware. Through eSPI, the BMC transmits NVMe drive configuration data to the PCH 170, which in turn communicates with the clock buffer via SMBus to apply the appropriate spread spectrum settings.

Another enhancement is the BMC's ability to dynamically adjust PCIe retimer EQ settings to optimize signal integrity. The firmware update includes a database stored in the BMC's ROM or onboard memory, containing pre-configured EQ values tailored for different NVMe drive models. Upon detecting a drive's model number, the BMC retrieves the corresponding EQ value and transmits it to the PCIe retimer via I2C.

In addition to signal configuration, the BMC is also responsible for power and thermal management. The system continuously monitors power consumption through eFuse feedback, which provides real-time current measurements. If the BMC detects sustained high current usage, it dynamically increases fan speeds to dissipate excess heat, ensuring system stability. Conversely, when power consumption decreases, the BMC reduces fan speed to conserve energy.

The execution of these tasks follows a structured workflow, beginning at system startup when the BMC retrieves NVMe drive information and applies the necessary configurations. Throughout system operation, the BMC continues to monitor power and thermal conditions, making real-time adjustments as needed. These enhancements transform the BMC into a centralized controller for NVMe drive management, providing a unified framework for signal configuration, EMI control, and power optimization.

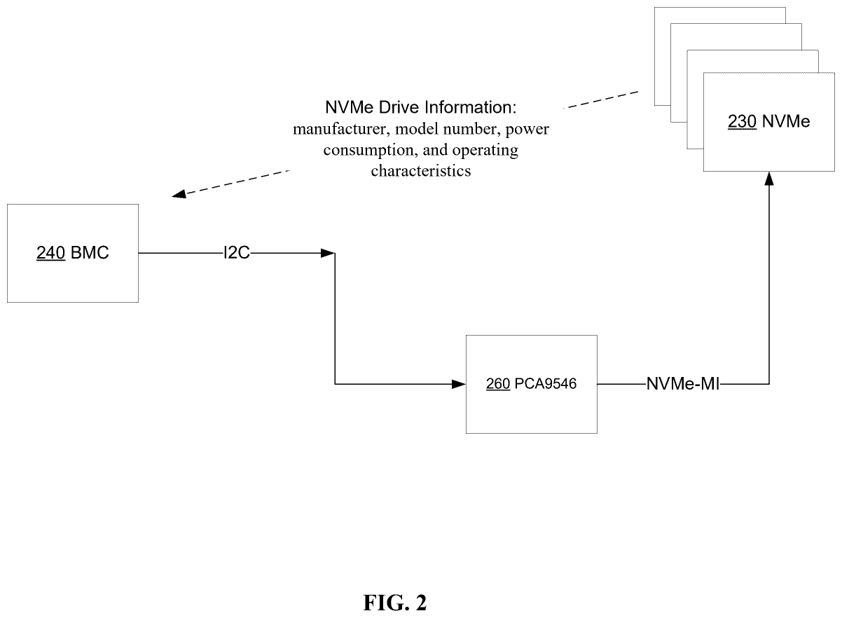

FIG. 2 is an example signal path for the BMC to retrieve NVMe configuration data via NVMe-MI, according to one example embodiment. The diagram illustrates the communication pathway between the Baseboard Management Controller (BMC) 240 and a plurality of NVMe drives 230, facilitated by a switch 260 (e.g., PCA9546). The diagram highlights how the BMC collects essential configuration data from the NVMe drives, enabling dynamic system management.

The BMC 240 is connected to the switch 260 through an I2C link or a SMBus link, which serves as a multiplexed communication interface. The switch 260 acts as an intermediary between the BMC 240 and the NVMe drives 230, allowing the BMC to selectively communicate with each drive. The switch 260 is further connected to the NVMe drives 230 via NVMe-MI, a protocol specifically designed for out-of-band management of NVMe storage devices.

Through this connection, the BMC 240 retrieves drive configuration data, including information such as manufacturer, model number, power consumption, and operating characteristics of each NVMe drive. By leveraging the I2C-based switch 260, the BMC can efficiently manage multiple NVMe drives without requiring direct, dedicated connections to each individual drive. Instead, the switch 260 provides a multiplexed pathway, allowing the BMC to access and query multiple NVMe drives.

The approach illustrated in FIG. 2 differs from existing solutions by leveraging an I2C-connected switch 260 to enable multiplexed communication between the BMC 240 and multiple NVMe drives 230 via NVMe-MI. In conventional implementations, NVMe drive configurations are often managed through system firmware or BIOS settings, requiring separate firmware versions or system-specific configurations to accommodate different drive models. These approaches introduce additional maintenance overhead, as firmware updates or manual configurations are needed when different NVMe drives are introduced into the system. By contrast, the multiplexed communication path via switch 260 allows the BMC 240 to dynamically retrieve NVMe drive information without requiring per-drive firmware modifications, reducing complexity and improving compatibility.

Additionally, existing solutions may rely on static, pre-configured settings for power consumption, signal integrity, or electromagnetic interference (EMI) control, requiring manual adjustments for different NVMe drive models. The proposed approach enables the BMC 240 to retrieve essential configuration data, including model number and power consumption, from each NVMe drive 230 in real time. This allows adaptive system configuration, where parameters such as spread spectrum clock settings or PCIe retimer equalization (EQ) values can be dynamically adjusted based on the retrieved data. As a result, the need for maintaining multiple BOM configurations is reduced, streamlining system design and improving flexibility in integrating different NVMe drives.

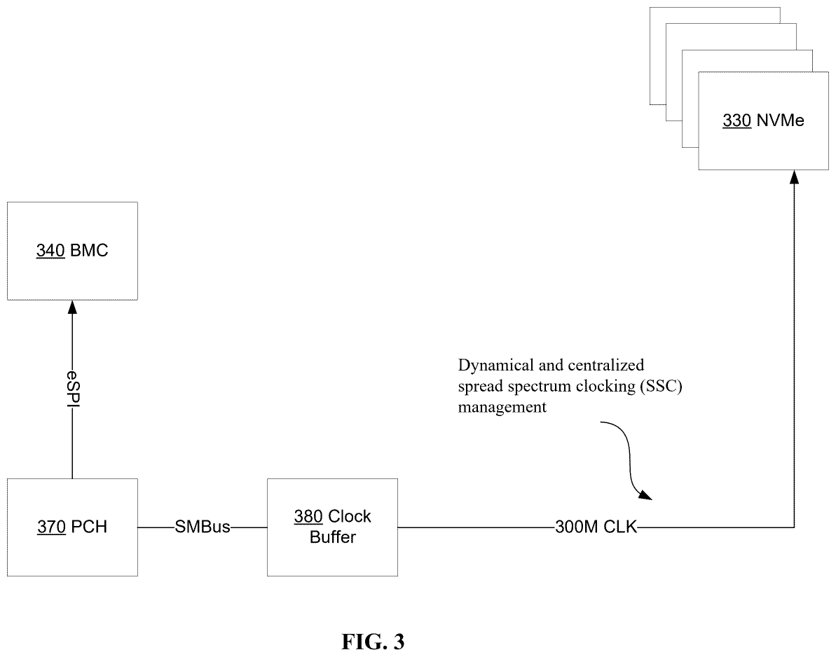

FIG. 3 is an example signal path for the BMC 340 to dynamically control SSC through the clock buffer, according to one example embodiment. It illustrates how the BMC configures SSC settings for NVMe drives 330 through a structured communication pathway, ensuring that SSC adjustments are applied based on the drive's configuration data to optimize EMI performance.

In the illustrated configuration, the BMC communicates with the PCH 370 via eSPI, allowing the BMC to transmit NVMe drive configuration data to the PCH 370, which includes manufacturer, model number, power consumption, and operating characteristics. Based on this data, the PCH 370 determines whether SSC should be enabled or disabled by referencing predefined system rules or errata information. The PCH 370 then transmits the command to the clock buffer 380 via SMBus. This indirect control structure enables dynamic SSC adjustments without modifying BIOS settings or requiring separate firmware versions for different NVMe drive models.

In some embodiments, the clock buffer, responsible for generating the 100 MHz reference clock, applies the SSC setting based on the control signal received from the PCH 370. If SSC is enabled, the clock buffer spreads the clock signal's frequency spectrum, reducing peak EMI emissions. If SSC is disabled, the clock buffer maintains a fixed clock frequency. The adjusted 100 MHz clock is then transmitted from the clock buffer to the NVMe drive 330, ensuring that the drive operates with the appropriate clocking configuration.

Unlike approaches that rely on static SSC settings configured in firmware or BIOS, this design enables real-time, drive-specific SSC adjustments. By leveraging the BMC to retrieve NVMe drive configuration data and dynamically applying SSC settings through the PCH and clock buffer, the system eliminates the need for manual configuration, enhances NVMe drive compatibility, and ensures compliance with EMC regulations.

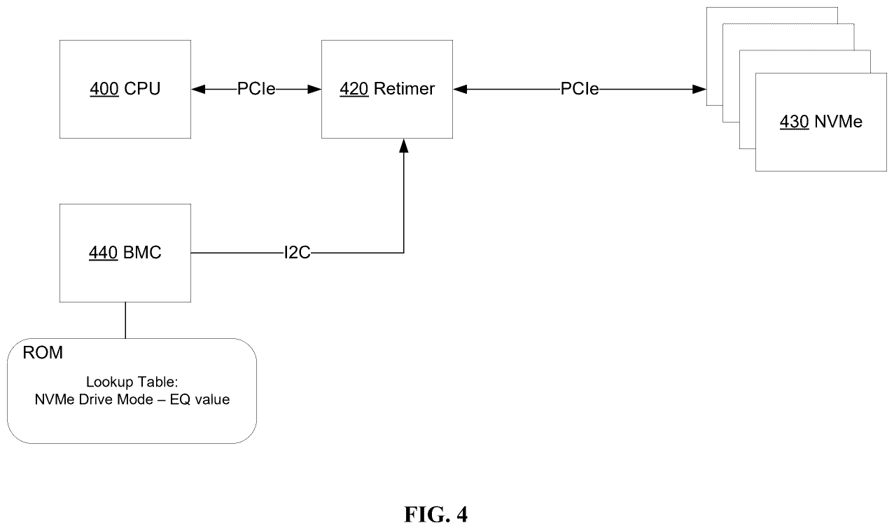

FIG. 4 is an example signal path for the BMC 440 to select and apply EQ values to the PCIe retimer 420, according to one example embodiment. The signal path illustrates how the BMC 440 dynamically configures the PCIe retimer's equalization (EQ) settings based on the NVMe drive model.

In this configuration, the BMC 440 pre-stores EQ values for various NVMe drive models in a lookup table within its ROM. These EQ values are determined through prior testing and tuning, ensuring that each drive model operates with an optimal PCIe signal quality. When the system boots, the BMC 440 retrieves the NVMe drive model information and cross-references it with the stored lookup table to identify the corresponding EQ value.

Once the appropriate EQ value is determined, the BMC transmits the selected setting to the PCIe retimer 420 via I2C or SMBus. The retimer applies the EQ setting to compensate for signal degradation, ensuring stable and reliable PCIe communication between the CPU 400 and the NVMe drive 430. The retimer 420 achieves this by adjusting key signal conditioning parameters, such as pre-emphasis, de-emphasis, receiver equalization (RX EQ), and transmitter equalization (TX EQ). These processes help mitigate signal loss, reflections, and crosstalk, which can occur as high-speed PCIe signals traverse PCB traces and connectors. Without proper equalization, data errors or transmission failures could arise, affecting the overall stability and performance of the NVMe drive.

This dynamic EQ selection process is particularly important because different NVMe drives 430 exhibit unique electrical characteristics. Some drives may require stronger signal boosting due to longer PCB traces or different transmission loss characteristics, while others may perform optimally with minimal adjustments. The ability to dynamically configure EQ values based on the detected NVMe drive model ensures that the PCIe retimer 420 is always tuned for the best possible signal integrity, regardless of the specific NVMe drive installed.

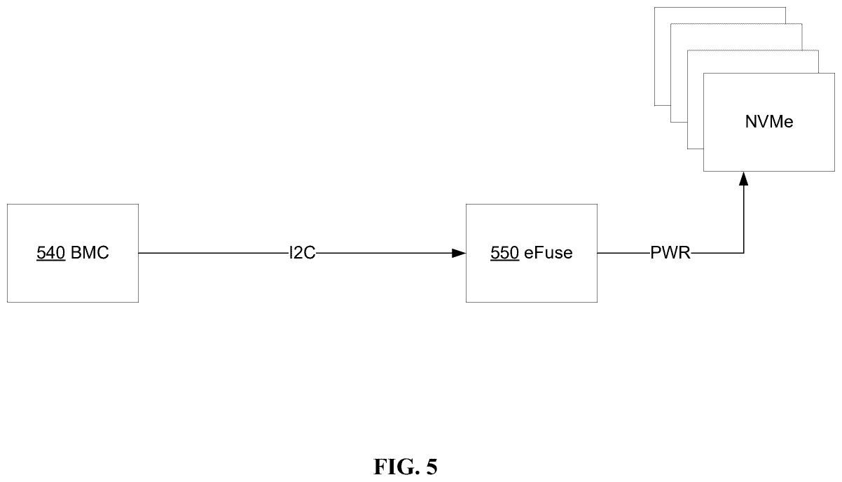

FIG. 5 is an example signal path for BMC 540 to use eFuse feedback 550 to dynamically adjust fan speed based on NVMe power consumption, according to one example embodiment. This signal path illustrates how the BMC 540 continuously monitors NVMe drive power usage through eFuse 550 and dynamically regulates fan speed to optimize thermal management.

In this configuration, the NVMe drive is connected to eFuse 550, which measures the power consumption of the drive in real time. The eFuse 550 provides current feedback to BMC 540, allowing the system to detect fluctuations in power usage. Unlike thermal management systems that rely on temperature sensors with slower response times, this approach enables the BMC 540 to anticipate power surges and adjust cooling mechanisms before excessive heat buildup occurs.

When the eFuse 550 detects a sustained high current draw, indicating that the NVMe drive is operating under heavy load, it sends this information to the BMC 540 via an I2C link or a SMBus link. Upon receiving this feedback, the BMC 540 increases the fan speed to enhance heat dissipation, preventing potential thermal throttling or drive failure. Conversely, when the power consumption of the NVMe drive decreases, the eFuse 550 reports the lower current levels to the BMC 540, which then reduces the fan speed to conserve power and minimize noise.

This approach provides several advantages over conventional thermal management methods. First, it allows proactive cooling adjustments based on power consumption trends rather than waiting for temperature thresholds to be exceeded. Second, it reduces overall power consumption by adjusting fan speeds dynamically rather than running them at a constant high speed. Third, by leveraging BMC 540 as a centralized controller, this system eliminates the need for separate cooling management hardware, simplifying system design and reducing costs.

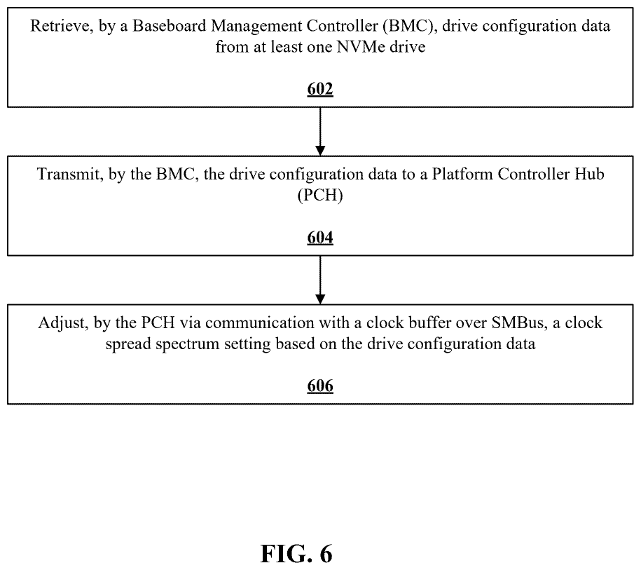

FIG. 6 illustrates an example method for managing NVMe drives using the unified management system, according to one example embodiment. In some implementations, one or more process blocks in FIG. 6 may be performed by a Baseboard Management Controller (BMC) on a motherboard.

As shown in FIG. 6, process 600 includes retrieving 602, by the BMC, drive configuration data from at least one NVMe drive. For example, the BMC retrieves drive configuration data from the NVMe drive as described earlier.

Process 600 further includes transmitting 604, by the BMC, the drive configuration data to a PCH or a suitable peripheral interface controller. The BMC sends this data to the PCH to facilitate subsequent configuration steps.

As shown in FIG. 6, process 600 also includes adjusting 606, by the PCH via communication with a clock buffer over SMBus, a clock spread spectrum setting based on the drive configuration data. This step allows the system to dynamically enable or disable spread spectrum clocking (SSC) for EMI mitigation based on the NVMe drive model.

In some implementations, process 600 may include additional steps or variations. These may be implemented individually or in combination with other implementations described herein.

In a first implementation, process 600 further includes determining, by the PCH based on the drive configuration data, whether to enable or disable the SSC feature and transmitting, by the PCH, a control signal to the clock buffer to enable or disable SSC for the NVMe drive.

In a second implementation, alone or in combination with the first implementation, process 600 includes selecting, by the BMC, a pre-configured equalization (EQ) value corresponding to the NVMe drive from stored EQ values and transmitting the selected EQ value to a PCIe retimer for application. Applying the selected EQ value improves the quality and reliability of high-speed PCIe signals between the CPU and the NVMe drive.

In a third implementation, alone or in combination with the first and second implementations, process 600 further includes monitoring, by the BMC via eFuse feedback, the power consumption of the NVMe drive and dynamically adjusting, by the BMC, server cooling parameters based on the monitored power consumption. This ensures efficient thermal management and power optimization.

In a fourth implementation, alone or in combination with one or more of the first through third implementations, process 600 further includes retrieving, by the BMC, the drive configuration data via (1) an I2C-connected switch or (2) an SMBus, and transmitting, by the BMC, the retrieved drive configuration data to the PCH via an eSPI interface.

Although FIG. 6 illustrates the example blocks of process 600, in some implementations, process 600 may include additional steps, fewer steps, different steps, or a rearranged sequence of steps from those depicted. Additionally, two or more blocks of process 600 may be performed in parallel.

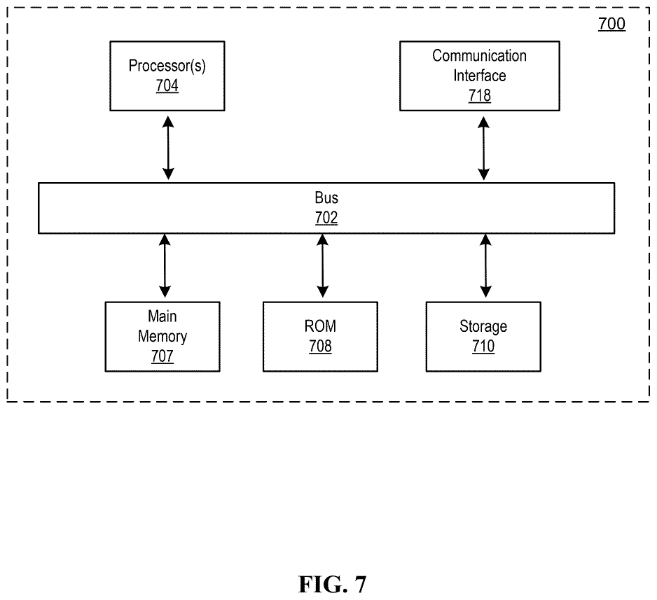

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 707, such as a random-access memory (RAM), cache and/or other dynamic storage devices, coupled to bus 702 for storing information and instructions to be executed by processor 704. Main memory 707 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing computer instructions for processor 704. A storage device 710, such as a magnetic disk, optical disk, or USB thumb drive (Flash drive), etc., is provided and coupled to bus 702 for storing information and instructions.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A system for managing NVMe storage devices, comprising:
a Baseboard Management Controller (BMC),
a peripheral interface controller, and
at least one NVMe drive,
wherein the BMC is configured to:
communicate with the at least one NVMe drive to retrieve drive configuration data of the at least one NVMe drive; and
transmit the drive configuration data of the at least one NVMe drive to the peripheral interface controller;
wherein the peripheral interface controller is configured to:
communicate with a clock buffer via SMBus to adjust clock spread spectrum based on the drive configuration data.

2. The system of claim 1, wherein the peripheral interface controller is further configured to communicate with the clock buffer via SMBus to enable or disable 100 MHz clock spread spectrum for the at least one NVMe drive based on device model information in the drive configuration data.

3. The system of claim 1, wherein the drive configuration data comprises manufacturer, model number, power consumption, and operating characteristics.

4. The system of claim 1, wherein the BMC is further configured to:
communicate with the at least one NVMe drive via (1) an I2C-connected switch or (2) an SMBus to retrieve the drive configuration data of the at least one NVMe drive.

5. The system of claim 1, wherein the BMC is further configured to:
transmit the drive configuration data of the at least one NVMe drive to the peripheral interface controller via an eSPI interface.

6. The system of claim 1, wherein the peripheral interface controller is further configured to:
determine, based on device model information in the drive configuration data, whether to enable a spread spectrum clock (SSC) feature to mitigate electromagnetic interference (EMI).

7. The system of claim 1, wherein the BMC is further configured to:
store pre-configured equalization (EQ) values for multiple NVMe storage device models; and
select an EQ value for the at least one NVMe drive based on device model of the at least one NVMe drive.

8. The system of claim 7, wherein the BMC is further configured to:
dynamically adjust EQ setting of a PCIe retimer by transmitting the selected EQ value to the PCIe retimer.

9. The system of claim 1, wherein the BMC is further configured to:
monitor power consumption of the at least one NVMe drive via eFuse feedback; and
dynamically adjust server cooling parameters based on the power consumption to optimize thermal management.

10. The system of claim 1, wherein the peripheral interface controller is further configured to regulate clock synchronization for the at least one NVMe drive.

11. A method for managing NVMe storage devices in a computing system, comprising:
retrieving, by a Baseboard Management Controller (BMC), drive configuration data from at least one NVMe drive;
transmitting, by the BMC, the drive configuration data to a peripheral interface controller; and
adjusting, by the peripheral interface controller via communication with a clock buffer over SMBus, a clock spread spectrum setting based on the drive configuration data.

12. The method of claim 11, further comprising:
determining, by the peripheral interface controller based on the drive configuration data, whether to enable or disable a spread spectrum clock (SSC) feature; and
transmitting, by the peripheral interface controller, a control signal to the clock buffer to enable or disable SSC for the at least one NVMe drive.

13. The method of claim 11, further comprising:
selecting, by the BMC, a pre-configured equalization (EQ) value corresponding to the at least one NVMe drive from stored EQ values; and
transmitting, by the BMC, the selected EQ value to a PCIe retimer for application, wherein applying the selected EQ value improves quality and reliability of high-speed PCIe signals between CPU and the at least one NVMe drive.

14. The method of claim 11, further comprising:
monitoring, by the BMC via eFuse feedback, power consumption of the at least one NVMe drive; and
dynamically adjusting, by the BMC, server cooling parameters based on the monitored power consumption.

15. The method of claim 11, further comprising:
retrieving, by the BMC, the drive configuration data via (1) an I2C-connected switch or (2) an SMBus; and
transmitting, by the BMC, the retrieved drive configuration data to the peripheral interface controller via an eSPI interface.

16. A Baseboard Management Controller (BMC) for managing NVMe storage devices, the BMC configured to:
communicate with at least one NVMe drive to retrieve drive configuration data; and
transmit the drive configuration data to a peripheral interface controller for system configuration adjustments.

17. The BMC of claim 16, wherein the BMC is further configured to:
retrieve the drive configuration data via (1) an I2C-connected switch or (2) an SMBus.

18. The BMC of claim 16, wherein the peripheral interface controller is further configured to:
determine, based on the drive configuration data, whether to enable or disable a spread spectrum clock (SSC) feature to mitigate electromagnetic interference (EMI).

19. The BMC of claim 16, wherein the BMC is further configured to:
store pre-configured equalization (EQ) values for multiple NVMe storage device models;
select an EQ value corresponding to the at least one NVMe drive based on device model information; and
transmit the selected EQ value to a PCIe retimer for application, wherein applying the selected EQ value improves quality and reliability of high-speed PCIe signals between CPU and the at least one NVMe drive.

20. The BMC of claim 16, wherein the BMC is further configured to:
monitor power consumption of the at least one NVMe drive via eFuse feedback; and
dynamically adjust server cooling parameters based on the monitored power consumption.
